(19) United States
(12) Patent Application Publication
(10) Pub. No.: US 2018/0052577 A1
(43) Pub. Date: Feb. 22, 2018

(54) DISPLAY CONTROL APPARATUS, METHOD FOR CONTROLLING THE SAME, AND STORAGE MEDIUM

(71) Applicant: CANON KABUSHIKI KAISHA, Tokyo (JP)

(72) Inventors: Yosuke Takagi, Yokohama-shi (JP); Katsuhito Yoshio, Tokyo (JP); Natsuko Miyazaki, Mitaka-shi (JP); Shingo Yamazaki, Tokyo (JP)

(21) Appl. No.: 15/679,057

(22) Filed: Aug. 16, 2017

(30) Foreign Application Priority Data
Aug. 22, 2016 (JP) 2016-161916

(51) Int. Cl. G06F 3/0485; G06F 3/0488; G06F 9/44

(52) U.S. Cl. CPC G06F 3/0485; H04N 5/23293; G06F 9/4446; G06F 3/04883

(57) ABSTRACT

A display control apparatus includes a display control unit that performs control to display a display target on a display unit, a reception unit that receives a scroll instruction to scroll the display target, and a control unit that performs control to scroll the display target based on receipt of the scroll instruction when an edge of the display target, which is a part of the display target, is not displayed on a predetermined region of the display unit, and to stop the scroll and darken the display target based on the scroll instruction when the edge of the display target is displayed on the predetermined region before the scroll instruction ends.

### BACKGROUND

### Field

The present disclosure relates to a display control apparatus and a method for controlling the display control apparatus, and, in particular, to a technique for displaying an edge of a display target.

### Description of the Related Art

Conventionally, there has been known a display apparatus configured to display a partial region of an image on a display unit and enable a user to confirm the image while changing the region to be displayed according to a user operation. Japanese Patent Application Laid-Open No. 2012-137821 proposes that an arrival of an edge of the image at an edge of the display unit is indicated by displaying the displayed region in a stretched state if the user issues an instruction to move the image toward a further edge when the edge of the image is displayed.

When the edge of the image is displayed and the image cannot be moved more than that, even if the user issues the instruction to move the image in the further edge direction, it is helpful to notify the user of the arrival at the edge of the image. In the case where the displayed region is displayed in the stretched state without the user's intention when the edge of the image is at the edge of the display unit as discussed in Japanese Patent Application Laid-Open No. 2012-137821, the user can be unaware of whether an operation that the user is performing is input as another instruction such as an enlargement instruction or the edge of the image is at the edge of the display unit.

### SUMMARY

The present disclosure is directed to providing a display control apparatus that clearly notifies a user that an edge of a display target is displayed and the display target cannot be moved in a further edge direction.

According to an aspect of the present disclosure, a display control apparatus includes a display control unit configured to perform control to display a display target on a display unit, a reception unit configured to receive a scroll instruction to scroll the display target, and a control unit configured to perform control to scroll the display target based on receipt of the scroll instruction when an edge of the display target, which is a part of the display target, is not displayed on a predetermined region of the display unit, and to stop the scroll and darken the display target based on the scroll instruction when the edge of the display target is displayed on the predetermined region before the scroll instruction ends.

According to another aspect of the present disclosure, a display control apparatus includes a display control unit configured to perform control to display a display target on a display unit, a reception unit configured to receive a scroll instruction to scroll the display target, and a control unit configured to perform control to, if the reception unit receives the scroll instruction when an edge of the display target, which is a part of the display target, is not displayed on a predetermined region of the display unit, scroll the display target by an amount based on a strength of the scroll instruction if the strength of the scroll instruction is weaker than a predetermined strength, and to stop the scroll and gradually darken the display target based on a display of the edge of the display target on the predetermined region if the strength of the scroll instruction is stronger than the predetermined strength.

According to yet another aspect of the present invention, a display control apparatus includes a display control unit configured to perform control to display a display target on a display unit, a reception unit configured to receive a scroll instruction to scroll the display target, and a control unit configured to perform control to scroll the display target based on receipt of the scroll instruction when an edge of the display target, which is a part of the display target, is not displayed on a predetermined region of the display unit, to stop the scroll when the edge of the display target is displayed on the predetermined region before the scroll instruction ends, and to gradually change a color saturation or a luminance of the display target based on the scroll instruction without scrolling the display target if the scroll instruction is received with the edge of the display target displayed on the predetermined region.

Further features will become apparent from the following description of exemplary embodiments with reference to the attached drawings.

### BRIEF DESCRIPTION OF THE DRAWINGS

FIG. 1 illustrates an outer appearance of a digital camera as one example of an apparatus to which a configuration of an exemplary embodiment is applicable.

FIG. 2 is a block diagram illustrating an example of a configuration of the digital camera as one example of the apparatus to which the configuration of an exemplary embodiment is applicable.

FIG. 3 is a flowchart illustrating scroll processing according to an exemplary embodiment.

FIG. 4 is a flowchart illustrating flick processing according to an exemplary embodiment.

FIG. 5 is a flowchart illustrating Touch-Move processing according to an exemplary embodiment.

FIGS. 6A, 6B, 6C, 6D, 6E, 6F, 6G, and 6H illustrate examples of displays on a display unit according to an exemplary embodiment.

FIGS. 7A, 7B, 7C, 7D, and 7E illustrate examples of displays on the display unit according to an exemplary embodiment.

FIGS. 8A, 8B, and 8C illustrate displays according to an exemplary modification of an exemplary embodiment.

### DESCRIPTION OF THE EMBODIMENTS

Exemplary embodiments will be described in detail below with reference to the accompanying drawings. It is to be noted that the following exemplary embodiment is merely one example and can be appropriately modified or changed depending on individual constructions and various conditions of apparatuses. Thus, the present disclosure is in no way limited to the following exemplary embodiment.

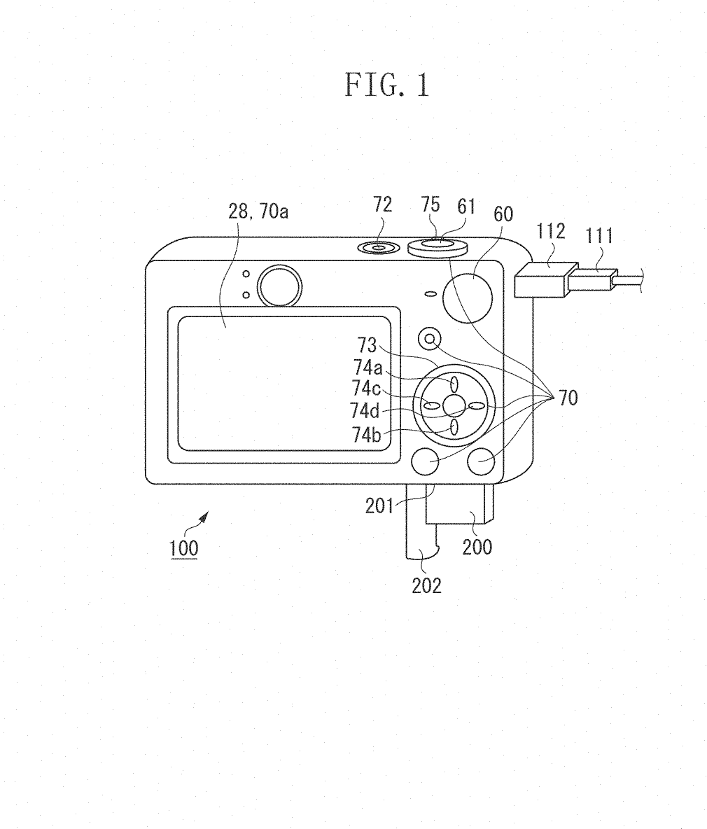

FIG. 1 illustrates an external appearance of a digital camera as one example of a display control apparatus according to an exemplary embodiment. A display unit 28 is a display unit where an image and various kinds of information are displayed. A touch panel 70a is provided that is integrated with the display unit 28. A shutter button 61 is an operation unit for issuing an imaging instruction, where the shutter button 61 receives the imaging instruction at a first stage and triggers imaging at a second stage when being pressed. A scale factor change lever 75 is provided to surround the shutter button 61, and enables a zoom ratio to be changed when a live view (LV) is displayed and a scale factor of a playback to be changed on a playback screen by being displaced to the left or the right.

A mode selection switch 60 is an operation unit for switching various kinds of modes. An operation unit 70 is an operation unit including operation members, such as various kinds of switches, a button, and a touch panel that receive various kinds of operations from a user. A dial 73 is a rotatably operable operation member included in the operation unit 70. Inside the dial 73, there are up, down, left, and right keys 74a, 74b, 74c, and 74d of a cross key 74. A power switch 72 is a button that is pressed for switching power-on and power-off. A connector 112 is a connector for connecting, for example, a connection cable 111, which is usable to connect to a personal computer (PC) or a printer, to the digital camera 100.

A recording medium 200 is a nonvolatile recoding medium, such as a memory card or a hard disk. A recording medium slot 201 is a slot for storing the recording medium 200. Storing the recording medium 200 into the recording medium slot 201 enables the recording medium 200 to communicate with the digital camera 100 and record and play back an image therein. A cover 202 is a cover of the recording medium slot 201. FIG. 1 illustrates the digital camera 100 with the cover 202 opened and the recording medium 200 partially extracted and exposed from the slot 201.

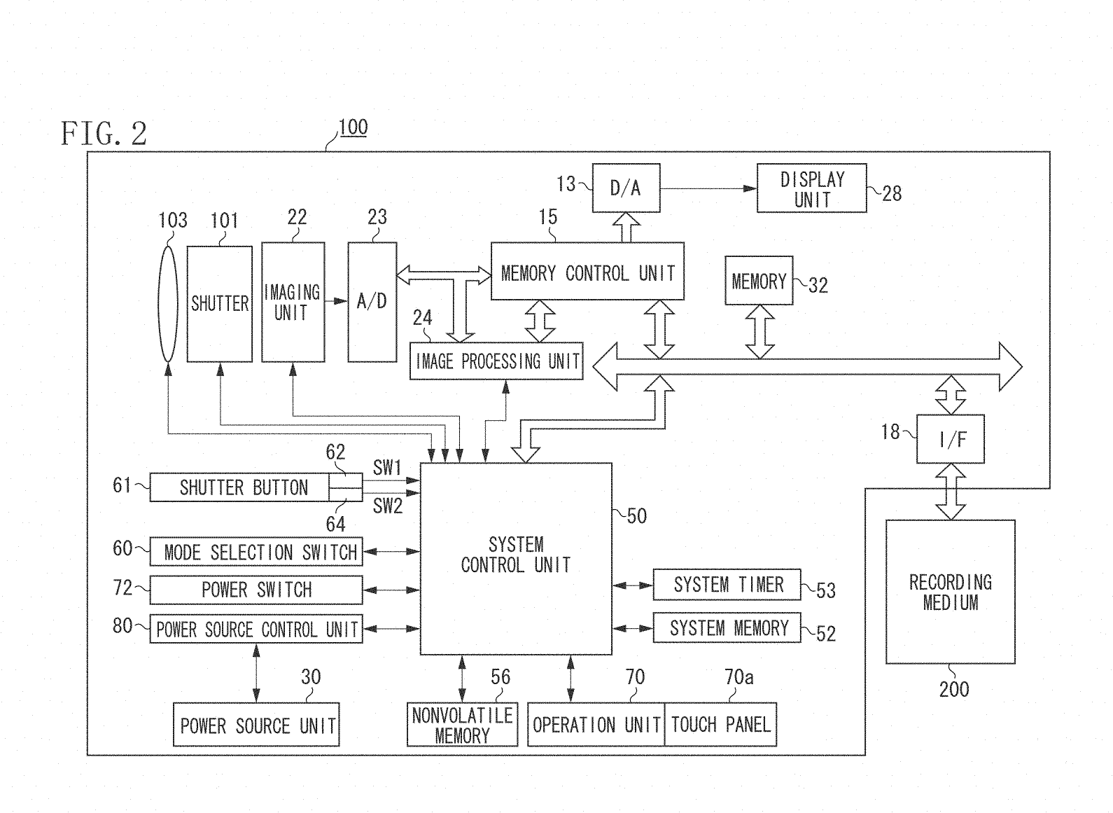

FIG. 2 is a block diagram illustrating an example of a configuration of the digital camera 100 according to the present exemplary embodiment.

In FIG. 2, an imaging lens 103 is a lens group including a zoom lens and a focus lens. A shutter 101 is a shutter including a diaphragm function. An imaging unit 22 is an image sensor constructed using, for example, a charge-coupled device (CCD) or complementary metal-oxide semiconductor (CMOS) element that converts an optical image into an electric signal. An analog-to-digital (A/D) converter 23 is used to convert an analog signal output from the imaging unit 22 into a digital signal.

An image processing unit 24 performs predetermined pixel interpolation, resizing processing such as a reduction, and color conversion processing on data from the A/D converter 23 or data from a memory control unit 15. The image processing unit 24 performs predetermined calculation processing using captured image data, and a system control unit 50 performs exposure control and ranging control based on an acquired result of the calculation. Based on this control, the digital camera 100 performs autofocus (AF) processing, automatic exposure (AE) processing, and electro focus (EF) (flash preliminary emission) processing of the Through-The-Lens (TTL) method. The image processing unit 24 also performs predetermined calculation processing using the captured image data, and the digital camera 100 also performs automatic white balance (AWB) processing of the TTL method based on an acquired result of the calculation.

The output data from the A/D converter 23 is written into a memory 32 via the image processing unit 24 and the memory control unit 15, or is directly written into the memory 32 via the memory control unit 15 without the intervention of the image processing unit 24. The memory 32 stores the image data acquired by the imaging unit 22 and converted into the digital data by the A/D converter 23, and image data to be displayed on the display unit 28. The memory 32 contains a storage capacity sufficient to store a predetermined number of still images or a moving image and audio data lasting for a predetermined time period.

The memory 32 also serves as a memory for an image display (a video memory). A digital-to-analog (D/A) converter 13 converts the data for the image display that is stored in the memory 32 into an analog signal, and feeds the converted data to the display unit 28. In this manner, the image data for the display that is written in the memory 32 is displayed by the display unit 28 via the D/A converter 13. The display unit 28 presents a display according to the analog signal from the D/A converter 13 on a display device, such as a liquid crystal display (LCD). The digital camera 100 can function as an electronic viewfinder and display a through-the-lens image (display the live view) by converting the digital signal first converted from the analog signal by the A/D converter 23 and then stored into the memory 32 into the analog signal by the D/A converter 13, and sequentially transferring this converted signal to the display unit 28 to display it thereon.

A nonvolatile memory 56 is a memory serving as a recording medium electrically erasable, recordable, and readable by the system control unit 50, and, for example, an electrically erasable programmable read only memory (EEPROM) is used as the nonvolatile memory 56. The nonvolatile memory 56 stores a constant, a program, and the like for an operation of the system control unit 50. The program described here refers to a computer program for performing various kinds of flowcharts, as described below, of the present exemplary embodiment.

The system control unit 50 includes at least one built-in processor, and controls the entire digital camera 100. The system control unit 50 realizes each processing procedure of the present exemplary embodiment as described below by executing the above-described program recorded in the nonvolatile memory 56. A random access memory (RAM) is used as a system memory 52. The constant and a variable for the operation of the system control unit 50, the program read out from the nonvolatile memory 56, and the like are extracted into the system memory 52. The system control unit 50 also performs display control by controlling the memory 32, the D/A converter 13, the display unit 28, and the like.

A system timer 53 is a time measurement unit that measures a time period for use in various kinds of control, and a time of a built-in clock. The mode selection switch 60, the shutter button 61, and the operation unit 70 are operation units for inputting various kinds of operation instructions to the system control unit 50.

The mode selection switch 60 switches an operation mode of the system control unit 50 to any of a still image recording mode, a moving image capturing mode, a playback mode, and the like. Modes contained in the still image recording mode include an automatic imaging mode, an automatic scene determination mode, a manual mode, various kinds of scene modes, each of which corresponds to an imaging setting prepared for each imaging scene, a program AE mode, a custom mode, and the like. The user can directly switch the operation mode to any of these modes contained in a menu screen using the mode selection switch 60. Alternatively, the user can switch the operation mode to any of these modes contained in the menu screen using another operation member after first switching the digital camera 100 to the menu screen using the mode selection switch 60. Similarly, the moving image capturing mode can also include a plurality of modes.

A first shutter switch 62 is switched on to generate a first shutter switch signal SW1 halfway through an operation of the shutter button 61 provided on the digital camera 100, i.e., upon a so-called half-press of the shutter button 61, which is considered an instruction to prepare for the imaging. In response to the first shutter switch signal SW1, the system control unit 50 starts operations, such as the AF processing, the AE processing, the AWB processing, and the EF (flash preliminary emission) processing.

A second shutter switch 64 is switched on to generate a second shutter switch signal SW2 upon completion of the operation of the shutter button 61, i.e., upon a so-called full-press of the shutter button 61, which is considered an instruction to carry out the imaging. In response to the second shutter switch signal SW2, the system control unit 50 starts a series of imaging processing operations from a still image capturing operation by the imaging unit 22 and reading out the signal from the imaging unit 22 to writing the image data into the recording medium 200.

The individual operation members of the operation unit 70 are appropriately assigned to functions for each scene and work as various kinds of functional buttons by, for example, execution of an operation of selecting various functional buttons displayed on the display unit 28. Examples of the functional buttons include an end button, a return button, an image jump button, a jump button, a depth-of-field preview button, and an attribute change button. For example, when a menu button is pressed, the menu screen, where various kinds of settings can be configured, is displayed on the display unit 28. The user can intuitively configure the various kinds of settings by using the menu screen displayed on the display unit 28, the up, down, left, and right four-way button 74, and a SET button.

A power source control unit 80 includes a battery detection circuit, a direct-current-to-direct-current (DC-DC) converter, a switching circuit that switches a block to which power is supplied, and the like. The power source control unit 80 detects whether a battery is mounted, a type of the battery, and a remaining battery level. The power source control unit 80 controls the DC-DC converter and supplies a required voltage to each of the units including the recording medium 200 for a required time period based on a result of this detection and an instruction from the system control unit 50. The power switch 72 is an operation member that receives the operation of switching power-on and power-off from the user.

A power source unit 30 includes a primary battery, such as an alkaline battery or a lithium battery, a secondary battery, such as a nickel-cadmium (NiCd) battery, a nickel metal hydride (NiMH) battery, or a lithium (Li) battery, an alternating-current (AC) adapter, and the like. A recording medium interface (I/F) 18 is an interface with the recording medium 200, such as a memory card or a hard disk. The recording medium 200 is a nonvolatile recording medium, such as a memory card, for recording the image at the time of imaging, and is constructed using a semiconductor memory, an optical disk, a magnetic disk, or the like.

The digital camera 100 includes the touch panel 70a, which can detect a touch on the display unit 28 (touch-detectable), as one element of the operation unit 70. The touch panel 70a and the display unit 28 can be integrated with each other. For example, the touch panel 70a is configured in such a manner that an optical transmittance thereof does not interfere with the display on the display unit 28, and is mounted on an upper layer of a display surface of the display unit 28. An input coordinate on the touch panel 70a and a display coordinate on the display unit 28 are associated with each other. This configuration can construct a graphical user interface (GUI) that provides the user with the appearance of being able to directly operate a screen displayed on the display unit 28.

The system control unit 50 can detect the following operations on or states of the touch panel 70a:

a finger or a stylus that has been touching the touch panel 70a touches the touch panel 70a. In other words, the touch is started (hereinafter referred to as a “Touch-Down”).

the touch panel 70a is in a state where the finger or the stylus is touching the touch panel 70a (hereinafter referred to as a “Touch-On”).

the finger or the stylus is moved while keeping in touch with the touch panel 70a (hereinafter referred to as a “Touch-Move”).

the finger or the stylus touching the touch panel 70a is removed from the touch panel 70a. In other words, the touch ends (hereinafter referred to as a “Touch-Up”).

the touch-panel 70a is in a state where nothing is touching it (hereinafter referred to as a “Touch-Off”).

When the “Touch-Down” is detected, a start of the “Touch-On” is also detected. After the “Touch-Down”, the detection of the “Touch-On” typically continues unless the “Touch-Up” is detected. The “Touch-Move” is detected in a state where the “Touch-On” is also detected. Even when the “Touch-On” is detected, the “Touch-Move” is not detected unless a touched position is being moved. After detection of the “Touch-Up” of all of the user's fingers or the stylus touching the touch panel 70a, the state of the touch panel 70a transitions to the “Touch-Off”.

The system control unit 50 is notified of these operations/states and a coordinate of the position touched by the finger or the stylus on the touch panel 70a via an internal bus, and determines what kind of operation is performed on the touch panel 70a based on the provided information. Regarding the “Touch-Move”, the system control unit 50 can also determine a movement direction of the finger or the stylus being moved on the touch panel 70a based on a change in the coordinate of the position for each of a vertical component and a horizontal component on the touch panel 70a.

A stroke is drawn when the “Touch-Up” is performed after the “Touch-Move” is performed in a predetermined manner from the “Touch-Down” on the touch panel 70a. An operation of quickly drawing the stroke is referred to as a “flick”. The flick is an operation of a user quickly moving the user's finger or stylus a certain distance while the finger or the stylus keeps touching the touch panel 70a, and then removing the finger or stylus from the touch panel 70a. In other words, the flick is an operation of quickly sliding a finger or stylus on the touch panel 70a. Such an operation performed within a predetermined time period that a time period from the start of the touch to the release of the touch is, for example, 0.5 seconds or 0.3 seconds will be referred to as the flick. The system control unit 50 can determine that the flick is performed when detecting that the “Touch-Move” is performed across a predetermined distance or longer at a predetermined speed or higher and detecting the “Touch-Up”. In addition, the system control unit 50 can determine that a “drag” is performed by detecting that the “Touch-Move” is performed across a predetermined distance or longer at a lower speed than a predetermined speed.

The touch panel 70a can be embodied by employing any type of touch panel from among touch panels based on various methods, such as the resistive film method, the capacitive method, the surface acoustic wave method, the infrared method, the electromagnetic induction method, the image recognition method, and the optical sensor method. A method that detects that the touch is input when the touch panel 70a is touched or a method that detects that the touch is input even when a finger or a stylus approaches the touch panel 70a without actually touching the touch panel 70a is employable depending on the type of the touch panel 70a.

The present exemplary embodiment is characterized by a display method when a plurality of images is displayed at the same time on the display unit 28 in the playback mode and scroll processing is performed. This display method will now be described.

Only a limited number of images can be displayed on a region of the display unit 28, so that the user can view images one after another by scrolling. The playback mode includes a multi-playback and a single-playback. The digital camera 100 displays a plurality of playback images recorded in the recording medium 200 (a recording unit) at the same time in the multi-playback, and displays a single playback image in the single-playback. The digital camera 100 can switch the displayed image(s) one after another in an order of being recorded in a file according to an instruction from the user in both the multi-playback and the single-playback.

The playback mode can be switched from the single-playback to the multi-playback by a pinch-in operation or an operation of the reduction lever, i.e., a rotation of the scale factor change lever 75 to the left. The playback mode can be switched from the multi-playback to the single-playback by a touch on an image, pressing of the SET button, or an operation of the enlargement lever, i.e., a rotation of the scale factor change lever 75 to the right). The playback mode is switched to a scroll playback by performing an operation of continuously switching the displayed image, i.e., quickly performing the “Touch-Move” a plurality of times or a continuous rotation of the dial 73) in the single-playback. In the scroll playback, images are displayed in a state arranged in a row with one image displayed at a center of the display unit 28 and two or four images displayed to the left and the right thereof.

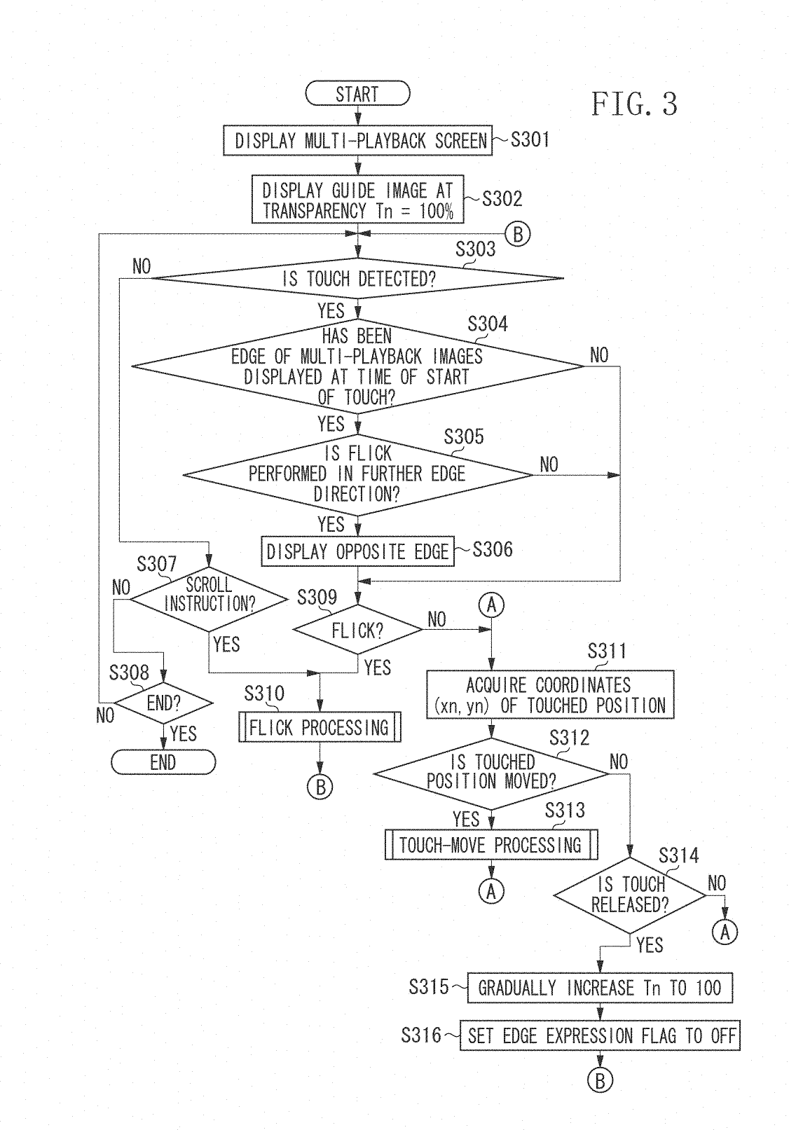

Scroll processing in the multi-playback according to the present exemplary embodiment will be described with reference to FIG. 3.

A program recorded in the nonvolatile memory 56 is extracted into the system memory 52 and executed by the system control unit 50 to realize the scroll processing. This processing is started when the digital camera 100 is powered on and the playback mode is selected and set to the multi-playback.

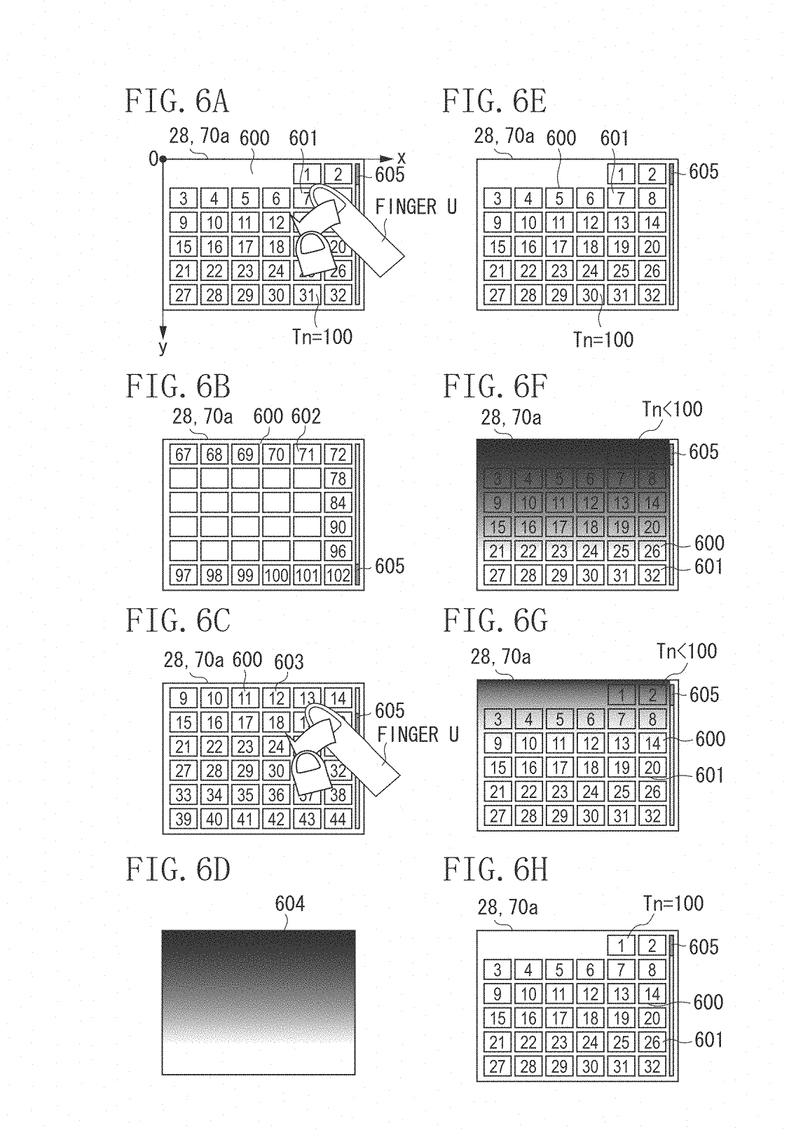

In step S301, the system control unit 50 displays a multi-playback screen 600, as illustrated in FIG. 6A, on the display unit 28. FIG. 6A illustrates one example of the multi-playback screen, which currently illustrates 32 playback images but can display as many as 36. A bar 605 indicates the vicinity where a region currently displayed on the display unit 28 is located from among the multi-playback images.

A number displayed on each of the images is illustrated for facilitating better understanding of an order in which an image file of each of the images recorded in the recording medium 200 is arranged, and is assumed to range from image 1 to image 102 in the present exemplary embodiment. Image 1 (a head image) and image 102 (a last image) are images placed at edges in the image file order. Assume that the images are displayed according to the image file order on the playback screen in any of the single-playback, the multi-playback, or the scroll playback. When the user scrolls to change the displayed region with an image list displayed in the multi-playback, the images are displayed one after another based on the image file order. Once the head image or the last image (i.e., the edge) is displayed, the movement temporarily stops there.

In step S302, the system control unit 50 presents a guide image 604, as illustrated in FIG. 6D, which is a guide image for the head image and a guide image for the last image (not illustrated) on the display unit 28 at a transparency T=100%. The guide image is an image for indicating to the user that the head image or the last image is displayed and the scroll processing cannot be performed more than that. The guide image is a monochrome gradation image. The playback images get darker and more invisible as the transparency T of the guide image is reduced.

An input of a “Touch-Move” or a flick triggers the scroll processing for moving the displayed images one after another as if they are flowing, but the scroll processing cannot continuously advance more than that if the edge during the scroll processing. When the head image or the last image is displayed during the scroll, temporarily stopping the scroll processing there facilitates a search for an image around the edge.

The guide image is an image for indicating to the user that the images are not moved even if an instruction to perform the scroll processing more than that is issued, i.e., the scroll reaches the edge of the image list. Because the user does not yet perform an operation of instructing the digital camera 100 to perform the scroll processing in step S302, the guide images are first presented at the transparency T=100%, i.e., in a state invisible from the user. The guide image 604 illustrated in FIG. 6D indicates an example of the guide image used to indicate that the scroll reaches the edge on the head image side (the guide image for the head), and colored in such a manner that a color density changes by gradation from a highest density on a top region of the display unit 28 to a lowest density on a bottom region of the display unit 28.

The guide image for indicating that the scroll reaches the edge on the last image side (the guide image for the last) is colored in such a manner that a color density changes by gradation from a highest density on the bottom region of the display unit 28 to a lowest density on the top region of the display unit 28. The guide image displayed at the transparency T=100% in step S302 does not necessarily have to be both the guide image 604 for the head and the guide image for the last, and the system control unit 50 can display one of them according to whether the multi-playback images currently displayed on the display unit 28 are close to the head image side or close to the last image side.

In step S303, the system control unit 50 determines whether a touch operation is performed on the touch panel 70a (the display unit 28). If the system control unit 50 determines that a touch operation is performed (YES in step S303), the processing proceeds to step S304. If not (NO in step S303), the processing proceeds to step S307.

In step S304, the system control unit 50 determines whether the edge of the multi-playback screen 600 was previously displayed at the time of the start of the touch in step S303. In other words, the system control unit 50 determines whether the display unit 28 has been in any of a state displaying a region 601 of the multi-playback screen 600 illustrated in FIG. 6A, where the head image is displayed and a state displaying a region 602 of the multi-playback screen 600 illustrated in FIG. 6B where the last image is displayed, among FIGS. 6A to 6H, or neither of them has been displayed.

No display of the edge of the multi-playback screen 600 indicates a state like a region 603, where neither the head image nor the last image is displayed, as illustrated in FIG. 6C. If the system control unit 50 determines that the edge of the multi-playback screen 600 has been already displayed (YES in step S304), the processing proceeds to step S305. If not (NO in step S304), the processing proceeds to step S309.

In a case where the images displayed on the display unit 28 are not so many as to necessitate the scroll, i.e., all of the playback images recorded in the recording medium 200 are displayed on the display unit 28, the system control unit 50 does not perform the scroll processing. Therefore, the system control unit 50 does not perform the processing in step S304 and steps subsequent thereto.

In step S305, the system control unit 50 determines whether a scroll instruction (a flick, a “Touch-Move”, pressing of the up/down key 74a or 74b, or a rotation of the dial 73 to the left or the right) is issued from a position of the currently displayed edge of the multi-playback screen 600 in the further edge direction. The scroll instruction is issued in a direction in which the dial 73 is rotated or a direction corresponding to the button 74. In other words, the system control unit 50 determines whether a scroll instruction for displaying a further upper image (an image located in a negative direction of a Y axis) is issued if the head image is currently displayed, and a scroll instruction for displaying a further lower image (an image located in a positive direction of the Y axis) is issued if the last image is currently displayed.

A finger U illustrated in FIG. 6A illustrates how a downward flick is input. This flick is handled as the instruction to display the image located in the negative direction of the Y axis. The downward flick started with the head image displayed causes the display to be switched to the other edge of the multi-playback screen 600. If the system control unit 50 determines that a scroll instruction is issued from the position of the currently displayed edge in the further edge direction (YES in step S305), the processing proceeds to step S306. If not (NO in step S305), the processing proceeds to step S309.

In step S306, the system control unit 50 displays, on the display unit 28, the edge of the multi-playback screen 600 on the opposite side from the edge displayed on the display unit 28 in step S304. In other words, the system control unit 50 switches the displayed multi-playback screen 600 from a region where images placed around the beginning (or the end) of the folder order are displayed to a region where images placed around the end (or the beginning) are displayed. If a downward flick, a downward “Touch-Move”, pressing of the up key 74a, or a rotation of the dial 73 to the left is input when the region 601 of the multi-playback screen 600 containing the head image is displayed as illustrated in FIG. 6A, the displayed multi-playback screen 600 is switched to the region 602 containing the last image that is illustrated in FIG. 6B.

In step S307, the system control unit 50 determines whether a scroll instruction is issued with an operation other than the touch operation, such as pressing of the up/down key 74a or 74b or a rotation of the dial 73 to the left or the right. When the edge of the multi-playback screen 600 is not displayed, the pressing of the up/down key 74a or 74b causes the images to be moved by a height corresponding to one row with the up/down key 74a or 74b pressed once, and the rotation of the dial 73 to the left or the right causes the images to be moved by the height corresponding to one row with the dial 73 rotated by a predetermined angle.

One row means, for example, images 67 to 72 or images 97 to 102 illustrated in FIG. 6B. In other words, when the dial 73 is rotated to the right or the down key 74b is pressed with the region 601 of the multi-playback screen 600 displayed and a cursor pointed at the image 1 or 2, the multi-playback screen 600 is moved to cause the images 1 and 2 to disappear from the display and images 33 to 38 to be newly added to the display. The not-illustrated cursor is used to indicate a currently selected image, and the key operation or the dial operation is handled as an instruction to move the cursor and is not handled as the scroll instruction when the cursor is not located at the edge or when the operation is not an operation toward the further edge even if the cursor is located at the edge. If the system control unit 50 determines that a scroll instruction is issued with an operation other than the touch operation (YES in step S307), the processing proceeds to step S310. If not (NO in step S307), the processing proceeds to step S308.

In step S308, the system control unit 50 determines whether to end the scroll processing in the multi-playback. The scroll processing in the multi-playback is ended by powering off the digital camera 100, switching the playback mode to the single-playback, switching the operation mode to the imaging mode, displaying the menu screen, or detecting a timeout. If the system control unit 50 determines to end the scroll processing in the multi-playback (YES in step S308), the system control unit 50 ends the scroll processing in the multi-playback. If not (NO in step S308), the processing returns to step S303, in which the system control unit 50 waits for an operation from the user.

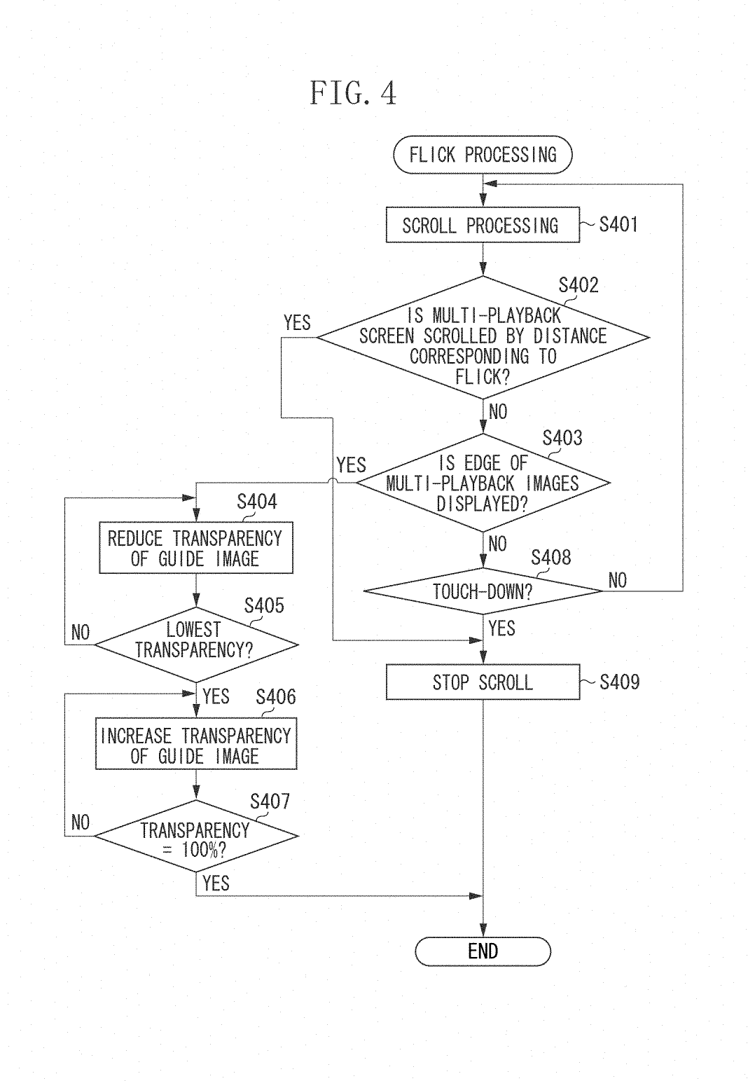

In step S309, the system control unit 50 determines whether a flick operation is performed in any of the upward and downward directions (the directions of the Y axis) on the touch panel 70a. If the system control unit 50 determines that a flick operation is performed in any of the upward and downward directions (YES in step S309), the processing proceeds to step S310. If not (NO in step S309), the processing proceeds to step S311. In step S310, the system control unit 50 performs flick processing. The flick processing will be described below with reference to FIG. 4.

In step S311, the system control unit 50 acquires coordinates (xn, yn) of a touched position on the touch panel 70a, and records the acquired coordinates into the system memory 52. The system control unit 50 acquires coordinates of a touched position when the touch operation has been started in step S303 if the processing proceeds from step S309 to step S311, and acquires coordinates of a current touched position if the processing proceeds from step S313 or S314 to step S311. Assume that the coordinates on the touch panel 70a are defined in such a manner that an origin point, a positive direction of an X axis, and the positive direction of the Y axis thereof are set to an upper left corner, a rightward direction, and the downward direction of the touch panel 70a as illustrated in FIG. 6A.

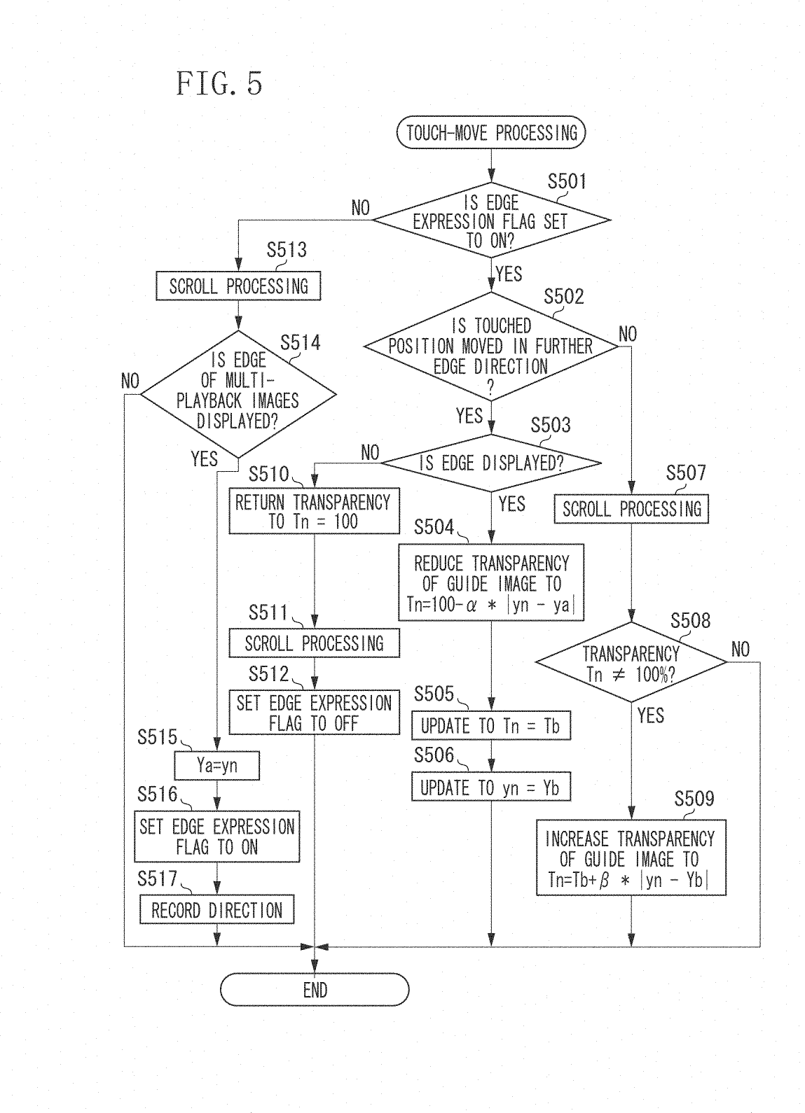

In step S312, the system control unit 50 determines whether the touched position is moved (a “Touch-Move” is performed) in any of the upward and downward directions (the directions of the Y axis). If the system control unit 50 determines that the touched position is moved (YES in step S312), the processing proceeds to step S313. If not (NO in step S312), the processing proceeds to step S314. In step S313, the system control unit 50 performs “Touch-Move” processing. The “Touch-Move” processing will be described below with reference to FIG. 5.

In step S314, the system control unit 50 determines whether the touch is released from the touch panel 70a. If the system control unit 50 determines that the touch is released, i.e., the touch operation performed until now ends (YES in step S314), the processing proceeds to step S315. If not (NO in step S314), the processing proceeds to step S311.

In step S315, the system control unit 50 gradually increases the transparency Tn of the guide image to 100%. The transparency Tn of the guide image can be reduced to a value lower than 100% in the “Touch-Move” processing illustrated in FIG. 5, which will be described below, but the system control unit 50 returns the transparency Tn to 100% by increasing the transparency Tn by a predetermined amount every time a predetermined time period has passed once the touch is released. For example, the system control unit 50 returns the transparency Tn to 100% by increasing the transparency Tn little by little, such as increasing the transparency Tn by 10% every 0.2 seconds or increasing the transparency Tn by 1% every 0.03 seconds. If the transparency Tn is 100%, the system control unit 50 does not perform the processing in step S315.

In step S316, the system control unit 50 sets an edge expression flag to OFF. The edge expression flag is a flag indicating that the edge of the multi-playback screen 600 is displayed on the display unit 28 while the multi-playback screen 600 is scrolled in FIG. 5, which will be described below. If the edge expression flag is set to ON, this indicates that the scroll processing cannot advance continuously from there and the multi-playback screen 600 no longer exists in the direction in which the scroll instruction is issued, more than that.

Next, the flick processing will be described with reference to FIG. 4. The program recorded in the nonvolatile memory 56 is extracted into the system memory 52 and executed by the system control unit 50, by which the flick processing is realized. This processing is started when the processing proceeds to step S310 illustrated in FIG. 3.

In step S401, the system control unit 50 performs the processing for scrolling the multi-playback screen 600. The scroll processing refers to processing for moving the region of the multi-playback screen 600 that is displayed on the display unit 28 little by little and gradually switching the images displayed on the display unit 28. In the present exemplary embodiment, the multi-playback screen 600 is scrolled only in the upward and downward directions. In the scroll processing, the displayed images are not entirely switched like step S306 illustrated in FIG. 3, but the images are gradually moved.

When the flick is performed, a distance by which the multi-playback screen 600 is moved is determined based on a speed at which the touched position is moved immediately before the touch is released and a time period during which the touch is maintained. As the touched position is moved at a higher speed and the touch is maintained for a shorter time period or as a finger/stylus flicks on the touch panel 70a more quickly and swiftly, the operation is input to the system control unit 50 as a stronger flick and the multi-playback screen 600 is also moved by a longer distance corresponding thereto.

When the flick operation is performed, the scroll processing continues by a distance according to the strength of the flick (continues only halfway if reaching the edge halfway), even if the user performs no operation after releasing the touch from the touch panel 70a. When the scroll processing is started with the flick, the system control unit 50 records a movement amount into the system memory 52.

In step S402, the system control unit 50 determines whether the multi-playback screen 600 is moved by the distance according to the strength of the flick. If the multi-playback screen 600 is moved by the distance according to the strength of the flick, the scroll processing ends. If the system control unit 50 determines that the multi-playback screen 600 is moved by the distance according to the strength of the flick (YES in step S402), the processing proceeds to step S409. If not (NO in step S402), the processing proceeds to step S403.

In step S403, the system control unit 50 determines whether the edge of the multi-playback screen 600 is displayed on the display unit 28. FIG. 6E illustrates a display when the edge of the multi-playback screen 600 is displayed on the display unit 28 (the region 601), i.e., the scroll comes to the edge, during the scroll processing triggered by the flick, and the transparency Tn of the multi-playback screen 600 is Tn=100%. After the edge of the multi-playback screen 600 is displayed, there is no image to be displayed more than that on a direction side according to the direction in which the user flicks the head image (there is no image beyond the head image in the file order), and therefore the scroll is also stopped.

In the present exemplary embodiment, if the edge of the multi-playback screen 600 is unexpectedly displayed on the display unit 28 during the scroll processing, the system control unit 50 does not perform the scroll processing more than that and displays an animation indicating that the scroll position reaches the edge. The display of the animation presented when the scroll position reaches the edge will be described below. If the system control unit 50 determines that the edge of the multi-playback screen 600 is displayed on the display unit 28 (YES in step S403), the processing proceeds to step S404. If not (NO in step S403), the processing proceeds to step S408.

Processing from steps S404 to S407 is processing for gradually reducing the transparency Tn of the guide image to indicate to the user that the scroll position reaches the edge when the edge of the multi-playback screen 600 is displayed during the scroll processing triggered by the flick, and then gradually increasing the transparency Tn of the guide image again after that. In other words, this processing indicates to the user that a movement toward the edge more than that is impossible by displaying the guide image while making the guide image gradually fade in after the scroll position reaches the edge, and then returns the display to the originally presented display by making the guide image fade out.

In step S404, the system control unit 50 gradually reduces the transparency Tn of the guide image 604. The system control unit 50 gradually reduces the transparency Tn, for example, by 10% every 0.2 seconds or by 1% every 0.03 seconds. FIG. 6F illustrates a display in the middle of gradually reducing the transparency Tn from 100% after the edge of the multi-playback screen 600 is displayed in FIG. 6E, and the guide image 604 is displayed at a higher density.

The guide image 604 is not superimposed on the bar 605, so that the transparency is not changed there. In this manner, the system control unit 50 gradually reduces the transparency Tn of the guide image according to the arrival at the edge without moving the multi-playback screen 600, which enables the user to be aware that the multi-playback screen 600 is not moved more than that. This however, does not mean that the processing by the flick is disabled. Only simply refraining from moving the multi-playback screen 600 can cause the user not to understand whether the user can further scroll (there is an image preceding to the image 1 in the file order), the scroll is stopped, the flick operation itself is disabled, or the scroll position reaches the edge.

Abruptly displaying the image at a low transparency (the transparency Tn=20% or the like) immediately after the scroll position reaches the edge can mislead the user into believing that the scroll position does not reach the edge, but a new display of something is started. Therefore, reducing the transparency Tn of the guide image to make the guide image gradually fade in can notify the user that the scroll position comes to the edge and there is no image to be displayed more than that even if a downward flick is input.

The gradual change of the display region in the scroll processing, and the gradual change of the transparency Tn are equivalent to each other in terms of a gradual change of the display as time goes by. It is highly likely that the user can easily be made aware that the scroll position reaches the edge.

In step S405, the system control unit 50 determines whether the transparency Tn of the guide image 604 is reduced to a lowest transparency. The lowest transparency refers to a minimum value of the transparency Tn of the guide image in the animation when the scroll position reaches the edge during the flick processing, i.e., a transparency when the guide image is displayed at a highest density. The transparency Tn of the guide image is gradually increased after being first reduced to the lowest transparency. The lowest transparency can be, for example, a value such as 20% and 10%, or can be any value as long as this value is greater than or equal to 0 and less than 100.

Alternatively, the lowest transparency can be changed according to a remaining distance that is acquired by subtracting a distance by which the multi-playback screen 600 is actually moved from the distance according to the strength of the flick. In other words, compared with such a flick that the scroll distance that would be satisfied if the scroll does not reach the edge after the movement is a distance α, the transparency Tn is reduced after the scroll position reaches the edge more greatly for such a flick that this distance is a distance β (>α). If the user flicks when a position at a distance shorter than the distance α to the edge is displayed, the transparency Tn is reduced more greatly by an amount corresponding to a difference between the distances β−α when the user flicks with an intention to move the multi-playback screen 600 by the distance β.

If the system control unit 50 determines that the transparency Tn is reduced to the lowest transparency (YES in step S405), the processing proceeds to step S406. If not (NO in step S405), the processing returns to step S404 and the system control unit 50 reduces the transparency Tn until the transparency Tn reaches the lowest transparency.

In step S406, the system control unit 50 gradually increases the transparency Tn of the guide image 604. The system control unit 50 gradually increases the transparency Tn, for example, by 10% every 0.2 seconds or by 1% every 0.03 seconds. FIG. 6G illustrates a display in the middle of gradually increasing the transparency Tn again after the transparency Tn is reduced to the lowest transparency. The system control unit 50 reduces the transparency Tn in step S404 and increases the transparency Tn in step S406 at the same speed, but can be configured in such a manner that the gradual increase in step S406 progresses at a higher speed.

In step S407, the system control unit 50 determines whether the transparency Tn of the guide image 604 reaches Tn=100%. FIG. 6H illustrates the multi-playback screen 600 when the transparency Tn is returned to Tn=100% after being reduced to the lowest transparency. In other words, when the scroll position reaches the edge during the scroll processing triggered by the flick, the transparency Tn is first reduced as illustrated from FIGS. 6E to 6F, and, after that, is increased again as illustrated in FIG. 6G and eventually returned to 100% as illustrated in FIG. 6H. If the system control unit 50 determines that the transparency Tn reaches Tn=100% (YES in step S407), the system control unit 50 ends the flick processing. If not (NO in step S407), the processing returns to step S406 and the system control unit 50 continues increasing the transparency Tn until the transparency Tn is returned to Tn=100%.

In step S408, the system control unit 50 determines whether a “Touch-Down” (a start of a touch) is performed on the touch panel 70a. If the system control unit 50 determines that a “Touch-Down” is performed (YES in step S408), the processing proceeds to step S409. If not (NO in step S408), the processing returns to step S401. If a “Touch-Down” is performed (YES in step S408) after the system control unit 50 determines that the edge of the multi-playback screen 600 is not yet displayed on the display unit 28 in step S403 (NO in step S403) and the processing proceeds to step S408, the scroll processing stops.

In step S409, the system control unit 50 stops the scroll processing. If the processing proceeds to step S409 after the system control unit 50 determines YES in step S402, a speed at which the scroll advances is gradually slowed down and the scroll is eventually stopped. If the processing proceeds to step S409 after the system control unit 50 determines YES in step S408, the system control unit 50 controls the display to display the region of the multi-playback screen 600 that has been displayed on the display unit 28 when the “Touch-Down” has been performed in step S408.

Next, the “Touch-Move” processing will be described with reference to FIG. 5. The program recorded in the nonvolatile memory 56 is extracted into the system memory 52 and executed by the system control unit 50, by which the “Touch-Move” processing is realized. This processing is started when the processing illustrated in FIG. 3 proceeds to step S313.

In step S501, the system control unit 50 determines whether the edge expression flag is set to ON. The edge expression flag is the flag indicating that the edge of the multi-playback screen 600 is displayed during a “Touch-Move”. If a “Touch-Move” is performed in the further edge direction when the edge expression flag is set to ON, the system control unit 50 displays the guide image while making the guide image gradually fade in to indicate to the user that the scroll position reaches the edge, without performing the scroll processing. If the system control unit 50 determines that the edge expression flag is set to ON (YES in step S501), the processing proceeds to step S502. If not (NO in step S501), the processing proceeds to step S513.

Steps S502 to S512 are processing performed if the edge of the multi-playback screen 600 is displayed during the “Touch-Move” and the edge expression flag is set to ON (YES in step S501). Steps S503 to S506 indicate processing for reducing the transparency Tn of the guide image that is performed if a “Touch-Move” is performed in the further edge direction after the scroll position comes to the edge (YES in step S502), and steps S507 to S509 indicate processing for increasing the transparency Tn of the guide image that is performed if a Touch-Move is performed in an opposite direction after the scroll position comes to the edge (NO in step S502).

Steps S510 to S512 indicate processing performed if the user first scrolls in the opposite direction after the edge is displayed, but scrolls in the edge direction again (NO in step S503). Now, the “Touch-Move” in the further edge direction refers to a “Touch-Move” in a direction of the “Touch-Move” performed when the edge is displayed, and the “Touch-Move” in the opposite direction refers to a “Touch-Move” in an opposite direction from the “Touch-Move” direction when the edge is displayed.

In step S502, the system control unit 50 determines whether the “Touch-Move” processing is performed from the currently displayed edge of the multi-playback screen 600 in the further edge direction. Alternatively, if the processing proceeds from step S517 to step S502, the system control unit 50 determines whether a “Touch-Move” is performed in the same direction of the Y axis as the “Touch-Move” direction in the direction of the Y axis that has been recorded in step S517, which will be described below.

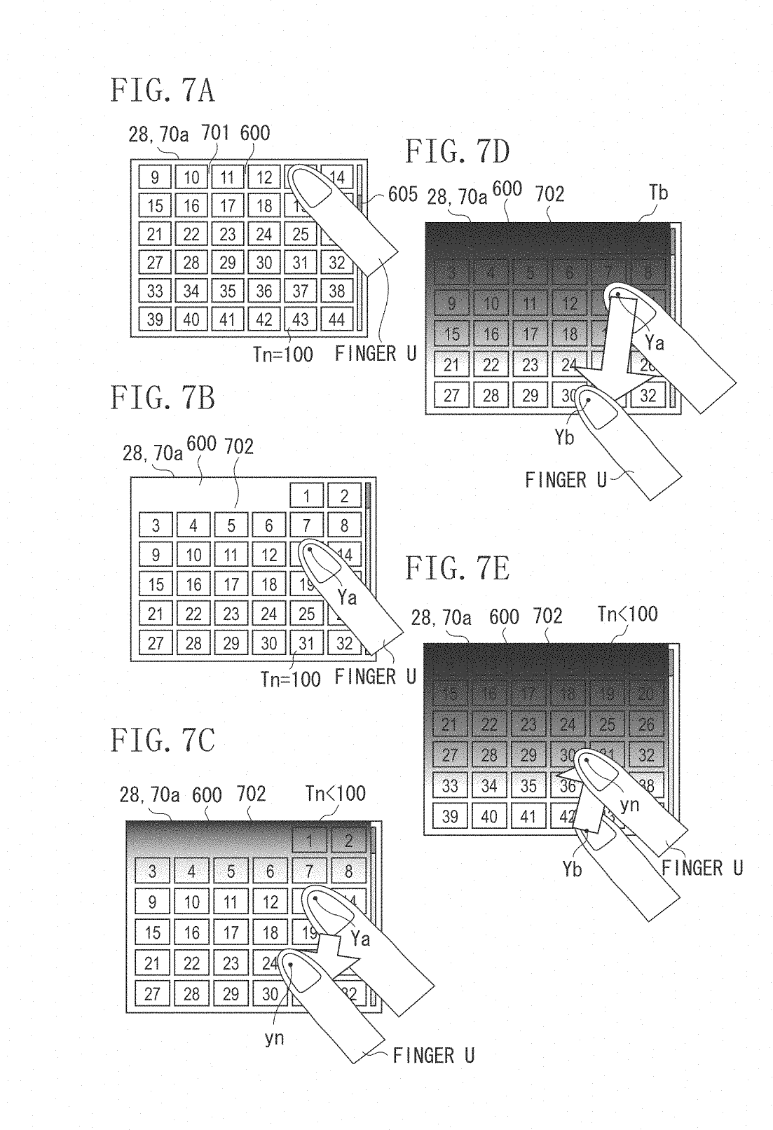

FIG. 7B illustrates a display when the scroll processing is performed downward from a region 701 illustrated in FIG. 7A and a region 702 is displayed, and an input of a downward scroll instruction directly from this state leads to YES as the determination in step S502. The system control unit 50 determines whether a “Touch-Move” is performed downward (in the positive direction of the Y axis) if the head image is displayed, and determines whether a “Touch-Move” is performed upward (in the negative direction of the Y axis) if the last image is displayed.

If the system control unit 50 determines that a “Touch-Move” is performed from the currently displayed edge of the multi-playback screen 600 in the further edge direction (YES in step S502), the processing proceeds to step S503. If not, i.e., if the system control unit 50 determines that a Touch-Move is performed from the currently displayed edge of the multi-playback screen 600 toward the edge in the opposite direction (NO in step S502), the processing proceeds to step S507.

In step S503, the system control unit 50 determines whether the edge of the multi-playback screen 600 is displayed. The region 701 illustrated in FIG. 7A leads to NO as the determination in step S503 because no edge is displayed therein, and the region 702 illustrated in FIG. 7B leads to YES as the determination in step S503 because containing the image 1, which is the head image. If the system control unit 50 determines that the edge is displayed (the head image or the last image is displayed) (YES in step S503), the processing proceeds to step S504. If not (NO in step S503), the processing proceeds to step S507.

In step S504, the system control unit 50 reduces the transparency Tn of the guide image 604 to Tn=100−α*|yn−Ya|. In other words, the system control unit 50 subtracts, from the transparency 100 when the scroll position reaches the edge, a value acquired by multiplying a distance in the direction of the Y axis by which the user moves the touched position in the further edge direction after the scroll position reaches the edge (a “Touch-Move” distance in the edge direction) by a predetermined number α.

A reference coordinate Ya is a Y-axis coordinate that the user touches with the user's finger U (or stylus) when the multi-playback screen 600 comes to the edge. In addition, yn is a Y-axis coordinate of the current touched position. The system control unit 50 compares the reference coordinate Ya and the value of the current Y-axis coordinate, and gradually increases the density of the guide image based on the distance by which the user performs the “Touch-Move” in the further edge direction after the scroll position reaches the edge.

The region displayed on the display unit 28 remains the region 702 and is unchanged even when the “Touch-Move” is performed as illustrated in FIG. 7C, but the transparency Tn of the guide image 604 is reduced. As illustrated in FIG. 7D, an input of a “Touch-Move” toward a further lower side than FIG. 7C causes a further reduction in the transparency Tn, and thus, an increase in the density of the guide image 604. Therefore, the transparency Tn exhibits the transparency Tn in FIG. 7C>the transparency Tn in FIG. 7D.

The predetermined number α can be determined based on a length of the touch panel 70a in the direction of the Y axis or can be kept constant. If a is set in such a manner that the transparency Tn is reduced from 100 to 20 when the “Touch-Move” is performed over approximately half of the Y axis of the touch panel 70a in a case where the touch panel 70a in the direction of the Y axis is 0≦y≦A, α is set to α=20%×(2/A).

In step S505, the system control unit 50 records Tn acquired in step S504 into the system memory 52 as the lowest transparency Tb. If a “Touch-Move” is performed in the opposite direction, the system control unit 50 uses the lowest transparency Tb recorded in step S505 because in this case, the transparency Tn is gradually increased from the lowest transparency Tb based on the distance of the “Touch-Move”. If the direction is switched from the downward “Touch-Move” to an upward “Touch-Move” at the time of FIG. 7D, the lowest transparency Tb at this time is used in step S509, which will be described below.

In step S506, the system control unit 50 records the coordinate yn of the current touched position in the direction of the Y axis into the system memory 52 as Yb. When gradually increasing the transparency Tn from the lowest transparency Tb based on the distance of the “Touch-Move” as described above in the description of step S505, the system control unit 50 compares Tb and the touched coordinate yn at this time.

In step S507, the system control unit 50 performs the scroll processing. In the scroll processing illustrated in FIG. 5, the region of the multi-playback images that is displayed on the display unit 28 is moved based on the movement of the touched position determined in step S312 illustrated in FIG. 3. An amount of the movement of the touched position and an amount of the movement of the region of the multi-playback images that is moved on the display unit 28 (a change amount) match each other. In other words, the multi-playback images are moved following the movement of the finger U (or the stylus)(the movement of the touched position).

In step S508, the system control unit 50 determines whether the transparency Tn is Tn≠100%. In other words, the system control unit 50 determines whether the transparency Tn of the guide image 604 is reduced from 100% and the guide image 604 is in a visible state. FIG. 7E illustrates a display on the display unit 28 after the scroll instruction is switched from the state in which the downward scroll instruction is issued in FIG. 7D to the upward scroll instruction.

As illustrated in FIG. 7E, if a “Touch-Move” is performed in the upward direction opposite from the direction of the “Touch-Move” when the scroll position comes to the edge, this leads to NO as the determination in step S502 (NO in step S502), so that the scroll processing is performed and thus a region 703 starts to be displayed. Therefore, the head image (the image 1) disappears from the display. Since the transparency Tn is Tn≠100 at the time of FIG. 7D, the transparency Tn is gradually increased based on the distance upon the input of the “Touch-Move” in the opposite direction. Therefore, the transparency Tn in FIG. 7D is lower than the transparency Tn in FIG. 7E.

If the system control unit 50 determines that the transparency Tn is Tn≠100% (YES in step S508), the processing proceeds to step S509. If not (the transparency Tn=100%) (NO in step S508), the system control unit 50 ends the “Touch-Move” processing. If the “Touch-Move” continues, the system control unit 50 determines YES again in step S312 illustrated in FIG. 3 and repeatedly performs the “Touch-Move” processing illustrated in FIG. 5.

In step S509, the system control unit 50 increases the transparency Tn of the guide image 604 to Tn=Tb+β|yn−Yb|. In other words, the system control unit 50 increases the transparency Tn by adding, to the lowest transparency Tb updated in step S505, a value acquired by multiplying a distance by which the touched position is moved in the direction of the Y axis from the touched position when the transparency Tn is reduced to the lowest transparency Tb by a predetermined number β. In this manner, the system control unit 50 controls the transparency Tn to gradually increase the transparency Tn from the updated lowest transparency Tb based on the distance of the “Touch-Move” from Yb, thereby making the guide image 604 gradually fade out.

Since the scroll processing has been performed in step S507, the digital camera 100 is brought into a state in step S509 that the guide image 604 is visible with the transparency Tn reduced to the transparency Tn<100, but the image at the edge is not displayed. Abruptly returning the transparency Tn to 100% makes the guide image 604 the user has been viewing look as if it disappears from the display, and therefore can mislead the user into believing that the currently displayed region is not close to the edge and an image at a further edge will be displayed if the user performs a “Touch-Move” once more. Therefore, the system control unit 50 reduces the transparency Tn little by little if reducing it after the scroll position comes to the edge, thereby notifying the user that the scroll position will unintentionally come to the edge if the user inappropriately performs a “Touch-Move” in the edge direction once more.

If the transparency Tn is prematurely reduced even when the scroll position does not yet come to the edge only because the scroll position approaches the edge, this can reduce visibility of the images due to the guide image 604 for the user who is aware of it, so the system control unit 50 refrains from changing the transparency Tn. In other words, the transparency Tn is not determined according to the displayed region. Even when the displayed region of the multi-playback screen 600 is the same, the system control unit 50 changes whether to reduce the transparency Tn or keep the transparency Tn at Tn=100% based on whether this region is displayed due to the “Touch-Move” in the opposite direction after the scroll position comes to the edge or displayed without the scroll position coming to the edge yet. By this control, the system control unit 50 can also notify the user that the scroll position comes to the edge while preventing the reduction in the visibility.

In step S510, the system control unit 50 returns the transparency Tn to Tn=100%. Step S510 is the processing performed if the system control unit 50 determines NO in step S503 (NO in step S503), so that the digital camera 100 is in a state that the edge is not displayed with the scroll processing having been performed in step S507 in the “Touch-Move” processing in the immediately preceding cycle or before that. Therefore, the “Touch-Move” has been performed in the further edge direction (in the same direction as step S517 since the edge has not been displayed) in step S502, so that the system control unit 50 returns the transparency Tn to 100%, thereby enabling the visibility of the images to be improved.

In step S511, the system control unit 50 performs the scroll processing. This processing is similar to step S507. In step S512, the system control unit 50 sets the edge expression flag to OFF, and records that into the system memory 52. The edge expression flag is set to OFF at this time, but the edge expression flag is set to ON if the scroll position comes to the edge again.

In step S513, the system control unit 50 performs the scroll processing. This processing is similar to step S507. In step S514, the system control unit 50 determines whether the edge of the multi-playback screen 600 is displayed on the display unit 28. If the system control unit 50 determines that the edge of the multi-playback screen 600 is displayed by the scroll processing in step S513 (YES in step S514), the processing proceeds to step S515. If not (NO in step S514), the system control unit 50 ends the “Touch-Move” processing.

In step S515, the system control unit 50 records the Y-axis coordinate into the system memory 52 as Ya=yn. Ya represents the coordinate of the touched position on the Y axis on the touch panel 70a when the scroll position comes to the edge. In step S516, the system control unit 50 sets the edge expression flag to ON, and records that into the system memory 52. In step S517, the system control unit 50 records into the system memory 52 the direction in which the “Touch-Move” has been performed when the scroll position has come to the edge in step S516. The direction of the “Touch-Move” recorded at this time is used in the determination in step S502.

According to the above-described exemplary embodiment, the user can be more clearly notified that the display region cannot be moved more than that in a particular direction based on an instruction from the user. After the images come to the edge, the images themselves that the user attempts to scroll are not moved when the processing for moving them toward the further edge is performed. Thus, the user is made aware that the scroll processing cannot be performed any more.

The system control unit 50 controls the display to gradually reduce the transparency Tn of the guide image, so that the user can confirm that the scroll instruction (the button 74, the dial 73, the flick, or the Touch-Move) issued by the user is actually input. Abruptly reducing the transparency Tn to a value as low as 0% or the like instead of gradually reducing it can mislead the user into believing that processing for presenting a new display is started.

The guide image is displayed at a higher density as the user continues to carry on the scroll instruction without noticing that the scroll position comes to the edge. Changing the density by an amount of the user operation eliminates a possibility that the visibility of the images is reduced because of the guide image without the user knowing that the scroll position comes to the edge. In other words, the digital camera 100 can notify the user that the scroll position comes to the edge while preventing the visibility of the images from being reduced.

In the present exemplary embodiment, the digital camera 100 has been described assuming that, if the instruction to move the screen toward the further edge is issued with the head image or the last image displayed, the other edge is displayed (step S306). The digital camera 100 can be configured not to cause the transition from one edge to the other edge. In other words, the digital camera 100 can be configured to, once the scroll position comes to the edge, always refrain from moving the screen more than that and gradually reduce the transparency Tn of the guide image even when the instruction to move the screen toward the further edge is issued.

The multi-playback screen 600 can be output to an external apparatus different from the display unit 28 as an external output, but the guide image is not displayed during the external output.

In the above-described exemplary embodiment, the digital camera 100 has been described assuming that the guide image is displayed with the transparency Tn thereof changed during the display of the multi-playback screen 600 as the display target, but can also be applied to the scroll playback of a screen that is not the multi-playback. For the scroll playback, a scroll instruction can be issued with a “Touch-Move” in the leftward/rightward direction (the direction of the X axis), a flick, pressing of the left/right key 74c or 74d, and a rotation of the dial 73. The display target can be a display when an image is displayed in an enlarged manner, a display at the time of the single-playback, the menu screen (a display of a list of items), a display of a list of icons, a map, a text, a document in which a map, a text, and the like are mixed, a table, and the like.

The present exemplary embodiment is also effective for not only the images recorded in the recording medium 200, but also a display target like one displayed while being downloaded, such as a web page, an image browsing application, or a screen displaying a mail list. The present exemplary embodiment has been described assuming that there are two edges, the head image and the last image as the edges of the displayed images, but the digital camera 100 can handle just the head image or just the last image.

### [Exemplary Modification]

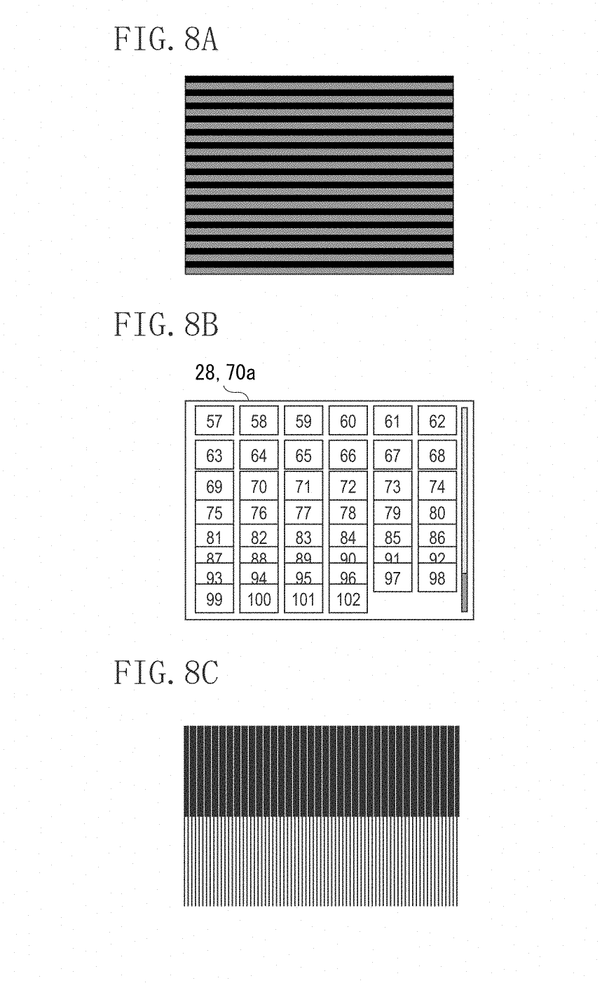

An exemplary modification of the present exemplary embodiment will be described with reference to FIG. 8.

The guide image is not limited to the example illustrated in FIG. 6D, and can be colored to keep a constant color density within the guide image as illustrated in FIG. 8A. Alternatively, the color can be varied in the guide image or a density of a pattern can be changed as illustrated in FIG. 8C.

The display control apparatus can display images (images 57 to 68) located in the opposite direction that have not been displayed until now without moving the image at the edge (the image 102) as illustrated in FIG. 8B without displaying the guide image, when being instructed to move the display region in the further edge direction with the edge of the multi-playback screen 600 displayed. The display control apparatus can present an expression as if something is actually stretched too much to be then accidentally torn and shrunk, when being instructed to perform the scroll processing from the edge in the further edge direction.

In each of the above-described exemplary embodiments, the display of the multi-playback images has been described assuming that the multi-playback images are darkened by changing the transparency Tn of the guide image. The method for darkening the scroll target, however, is not limited to the change in the transparency Tn. More specifically, the display control apparatus can be configured to gradually reduce a luminance of the display unit 28 or gradually increase a density of the display of the images.

Other examples of the display indicating that the scroll position reaches the edge include gradually making the images gray by changing a color saturation of the images, and a method that changes a luminance of the screen. The display control apparatus can indicate to the user that a scroll more than that is impossible by gradually changing the color saturation of the images from color images to gray images based on the amount of the “Touch-Move” or gradually increasing or reducing the luminance of the screen. The display control apparatus can change the luminance or the color saturation of the entire screen without using the gradation.

The display control apparatus can be configured to change the display manner by gradually changing (adding) an image to be superimposed on thumbnail images according to the distance of the “Touch-Move”.

Regarding the above-described various kinds of control that have been described assuming that the system control unit 50 performs them, a single hardware device can perform them, or a plurality of hardware devices can control the entire apparatus by dividing the processing among them.

The above-described exemplary embodiments are not seen to be limiting. Various embodiments within a range that does not depart from the spirit of the present disclosure are applicable. Each of the above-described exemplary embodiments merely indicate one exemplary embodiment, and the individual exemplary embodiments can also be arbitrarily combined.

The above-described exemplary embodiments have been described referring to the example of the digital camera 100. This example is not seen to be limiting, and the above-described embodiments can be applied to any apparatus as long as the apparatus controls the processing for scrolling a display target based on an instruction to perform the scroll processing.

More specifically, the present disclosure can be applied to a PC, a mobile phone terminal and a mobile image viewer, a digital photo frame, a music player, a game machine, an electronic book reader, a tablet PC, a smart-phone, a projector, home electronics equipped with a display unit, and the like. The present disclosure can also be applied to an apparatus such as a smart-phone, a tablet PC, or a desktop PC that receives a live view image captured by a digital camera or the like via wired or wireless communication and displays this image, and remotely controls the digital camera. The digital camera can include a network camera.

### Other Exemplary Embodiments

Exemplary embodiments can also be realized by performing the following processing. That is, the exemplary embodiments can be realized by processing that supplies software (a program) that realizes the above-described functions to a system or an apparatus via a network or various kinds of recording media, and causes a computer (or a central processing unit (CPU), a micro processing unit (MPU), or the like) of this system or apparatus to read out and execute a program code. In this case, the program and the recording medium storing the program constitute the invention.

According to the present disclosure, the user can be clearly notified that the edge of the display target is displayed and a movement in the further edge direction is impossible.

### Other Embodiments

Embodiment(s) can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While exemplary embodiments have been described, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2016-161916, filed Aug. 22, 2016, which is hereby incorporated by reference herein in its entirety.

What is claimed is:

1. A display control apparatus comprising:
a display control unit configured to perform control to display a display target on a display unit;
a reception unit configured to receive a scroll instruction to scroll the display target; and
a control unit configured to perform control to scroll the display target based on receipt of the scroll instruction when an edge of the display target, which is a part of the display target, is not displayed on a predetermined region of the display unit, and to stop the scroll and darken the display target based on the scroll instruction when the edge of the display target is displayed on the predetermined region before the scroll instruction ends.

2. The display control apparatus according to claim 1, wherein the control unit performs control to stop the scroll of the display target and further darken visibility of the display target when the edge of the display target is displayed on the predetermined region before the scroll instruction ends.

3. The display control apparatus according to claim 1, wherein the control unit performs control to darken the display target based on an amount of the scroll instruction issued after the edge of the display target is displayed on the predetermined region.

4. The display control apparatus according to claim 1, wherein the control unit performs control to gradually brighten the display target based on an end of the scroll instruction after darkening the display target.

5. The display control apparatus according to claim 1, further comprising a touch detection unit configured to detect a touch operation on the display unit,
wherein the scroll instruction is an operation of moving a touched position of the detected touch operation, and
wherein the control unit performs control to scroll the display target in a direction based on a direction in which the touched position is moved.

6. The display control apparatus according to claim 5, wherein an end of the scroll instruction is an operation of ending the touch operation.

7. The display control apparatus according to claim 1, wherein the control unit performs control to display an edge of the display target in a second direction that is an opposite direction from a first direction without darkening the display target based on receipt of an additional scroll instruction in the first direction when an edge of the display target in the first direction, which is a part of the display target, is displayed on the predetermined region, and to display the display target located in the second direction based on receipt of a scroll instruction in the second direction.

8. The display control apparatus according to claim 1, wherein the control unit performs control to perform scroll processing in a second direction and also brighten the display target from a first brightness based on issuance of a scroll instruction in the second direction that is an opposite direction from a first direction, after a scroll instruction in the first direction is issued and the edge of the display target is displayed on the predetermined region and a brightness of the display target is reduced to the first brightness based on issuance of an additional scroll instruction in the first direction.

9. The display control apparatus according to claim 1, further comprising a change unit configured to change a transparency of a guide presented while being superimposed on the display target on the display unit,
wherein the control unit performs control to darken the display target by reducing the transparency of the guide based on the scroll instruction.

10. The display control apparatus according to claim 1, wherein the display target is a plurality of images recorded in a recording unit that is arranged in a predetermined order.

11. The display control apparatus according to claim 9, wherein the guide is a gradation image.

12. The display control apparatus according to claim 10, wherein the edge of the display target is an image placed at an edge in the predetermined order from among the plurality of images recorded in the recording unit.

13. The display control apparatus according to claim 11, wherein the gradation image is more darkened at the edge of the display target that is displayed on the display unit.

14. A display control apparatus comprising:
a display control unit configured to perform control to display a display target on a display unit;
a reception unit configured to receive a scroll instruction to scroll the display target; and
a control unit configured to perform control to, if the reception unit receives the scroll instruction when an edge of the display target, which is a part of the display target, is not displayed on a predetermined region of the display unit, scroll the display target by an amount based on a strength of the scroll instruction if the strength of the scroll instruction is weaker than a predetermined strength, and to stop the scroll and gradually darken the display target based on a display of the edge of the display target on the predetermined region if the strength of the scroll instruction is stronger than the predetermined strength.

15. The display control apparatus according to claim 14, wherein the control unit performs control to darken the display target to a predetermined brightness after the edge of the display target is displayed on the predetermined region if the strength of the scroll instruction is stronger than the predetermined strength.

16. The display control apparatus according to claim 14, wherein a brightness of the display target is reduced by an amount based on a distance acquired by subtracting a distance by which the display target is scrolled based on the scroll instruction from a distance by which the display target would be scrolled if a scroll position does not reach the edge of the display target based on the scroll instruction.

17. The display control apparatus according to claim 14, wherein the control unit performs control to brighten the display target after darkening the display target.

18. The display control apparatus according to claim 14, wherein the scroll instruction is an operation of performing an operation of releasing a touch after a predetermined movement of a touched position from a start of the touch within a predetermined time period.

19. The display control apparatus according to claim 14, wherein the scroll instruction is an operation on a button or a dial, and
wherein the control unit performs control to scroll the display target based on a direction corresponding a pressing of the button or a direction corresponding to a rotating the dial.

20. A method for controlling a display control apparatus including a display unit, the method comprising:
displaying a display target on the display unit;
receiving a scroll instruction to scroll the display target;
scrolling the display target based on receipt of the scroll instruction when an edge of the display target, which is a part of the display target, is not displayed on a predetermined region of the display unit; and
stopping the scroll and darkening the display target based on the scroll instruction when the edge of the display target is displayed on the predetermined region before the scroll instruction ends.

21. A method for controlling a display control apparatus including a display unit, the method comprising:
displaying a display target on the display unit;
receiving a scroll instruction to scroll the display target;
scrolling, if the scroll instruction is received when an edge of the display target, which is a part of the display target, is not displayed on a predetermined region of the display unit, the display target by an amount based on a strength of the scroll instruction if the strength of the scroll instruction is weaker than a predetermined strength; and
stopping the scrolling and gradually darkening the display target based on a display of the edge of the display target on the predetermined region without scrolling the display target by the amount based on the strength of the scroll instruction if the strength of the scroll instruction is stronger than the predetermined strength.

22. A display control apparatus comprising:
a display control unit configured to perform control to display a display target on a display unit;
a reception unit configured to receive a scroll instruction to scroll the display target; and
a control unit configured to perform control to scroll the display target based on receipt of the scroll instruction when an edge of the display target, which is a part of the display target, is not displayed on a predetermined region of the display unit, to stop the scroll when the edge of the display target is displayed on the predetermined region before the scroll instruction ends, and to gradually change a color saturation or a luminance of the display target based on the scroll instruction without scrolling the display target if the scroll instruction is received with the edge of the display target displayed on the predetermined region.

23. A method for controlling a display control apparatus, the method comprising:
displaying a display target on a display unit;
receiving a scroll instruction to scroll the display target;
scrolling the display target based on receipt of the scroll instruction when an edge of the display target, which is a part of the display target, is not displayed on a predetermined region of the display unit;
stopping the scrolling when the edge of the display target is displayed on the predetermined region before the scroll instruction ends; and
gradually changing a color saturation or a luminance of the display target based on the scroll instruction without scrolling the display target if the scroll instruction is received with the edge of the display target displayed on the predetermined region.

24. A non-transitory computer-readable storage medium storing a program for executing a method for controlling a display control apparatus including a display unit, the method comprising:
displaying a display target on the display unit;
receiving a scroll instruction to scroll the display target;
scrolling the display target based on receipt of the scroll instruction when an edge of the display target, which is a part of the display target, is not displayed on a predetermined region of the display unit; and
stopping the scroll and darkening the display target based on the scroll instruction when the edge of the display target is displayed on the predetermined region before the scroll instruction ends.

25. A non-transitory computer-readable storage medium storing a program for executing a method for controlling a display control apparatus including a display unit, the method comprising:
displaying a display target on the display unit;
receiving a scroll instruction to scroll the display target;
scrolling, if the scroll instruction is received when an edge of the display target, which is a part of the display target, is not displayed on a predetermined region of the display unit, the display target by an amount based on a strength of the scroll instruction if the strength of the scroll instruction is weaker than a predetermined strength; and
stopping the scrolling and gradually darkening the display target based on a display of the edge of the display target on the predetermined region without scrolling the display target by the amount based on the strength of the scroll instruction if the strength of the scroll instruction is stronger than the predetermined strength.

26. A non-transitory computer-readable storage medium storing a program for executing a method for controlling a display control apparatus including a display unit comprising:
displaying a display target on the display unit;
receiving a scroll instruction to scroll the display target;
scrolling the display target based on receipt of the scroll instruction when an edge of the display target, which is a part of the display target, is not displayed on a predetermined region of the display unit;
stopping the scrolling when the edge of the display target is displayed on the predetermined region before the scroll instruction ends; and
gradually changing a color saturation or a luminance of the display target based on the scroll instruction without scrolling the display target if the scroll instruction is received with the edge of the display target displayed on the predetermined region.
